(19) United States
(12) Patent Application Publication
(10) Pub. No.: US 2026/0346495 A1
(43) Pub. Date: Nov. 5, 2026

(54) METHOD FOR IMPROVING THE RESISTANCE TO ROT AND TERMITES OF A WOODEN MATERIAL

(71) Applicant: ORGANOWOOD AB, Täby (SE)

(72) Inventors: Juhanes AYDIN, Sodertalje (SE); Salman HASSANZADEH, Vallentuna (SE)

(21) Appl. No.: 19/124,727

(22) PCT Filed: Dec. 11, 2023
(86) PCT No.: PCT/SE2023/051242

§ 371 Date: Apr. 25, 2025

(30) Foreign Application Priority Data
Dec. 9, 2022 (SE) 2251443-4

(51) Int. Cl. B27K 3/16; B27K 3/08

(52) U.S. Cl. CPC B27K 3/16; B27K 3/08

(57) ABSTRACT

The present invention relates to a method for treating a wooden material to improve the resistance to rot and termites of the wooden material, wherein the wooden material is treated with a water-based formulation comprising a zirconium salt followed by a drying step at a temperature from 0 degrees C to 100 degrees C. The method results in a rot resistant wooden material and with an improved termite resistance compared to a wooden material treated with the same water-based formulation but dried at a higher temperature.

### TECHNICAL FIELD

The present disclosure relates generally to a method for treating a wooden material to improve the wooden material's resistance to rot and termites. The method comprises applying a water-based formulation comprising a zirconium salt on the wooden material followed by a drying step. Further, the present disclosure also relates to a wooden material treated by such a method, and a product comprising such a wooden material.

### BACKGROUND ART

With an increased demand for wooden materials, for instance as building components and furniture, there is a growing need for wooden materials exhibiting resistance to out-door factors such as rot and insects.

A common insect causing great structural damage to wooden materials are termites. Termites are wood-consuming insects that feed on cellulose found in plants and wooden materials. When a wooden material is attacked by termites, the structural integrity of the material is impaired as the termites create voids within the material. As such, minimizing or completely eliminating termite attacks on wooden materials is of great importance if a wooden material is to be structurally stable over time.

Similarly also rot, caused by fungi, causes structural degradation of wooden materials.

Traditionally various biocides and pesticides have been used to preserve and protect wooden materials against rot and/or termites. These compounds very often have a negative impact on human health and environment. Therefore, there is still a need for a solution for improving a wooden material's resistance to rot and/or termites without having a negative impact on human health and environment.

Zirconium as the 20th element in abundance in the earth's crust lies in Group IVB of the periodic table. The polymeric species of zirconium in the aqueous solution can interact chemically and physically with different functional groups of organic polymers. The reaction of the aqueous zirconium species is known for example with carboxyl, hydroxyl, and amine groups. The reaction of the zirconium with functional groups of organic polymers can be controlled significantly by altering temperature, pH and chelating agents. The zirconium polymeric species based on the used amount, physical parameters and extent and type of the functionalities in the organic polymers can induce crosslinking bonds, improve adhesion properties of the treatments and surfaces and increase the resistance to heat, scrubbing, water and/or solvents.

Zirconium salts have previously been suggested as an agent to prevent microbial degradation of wood products, see for instance WO 2021/118450. However, this document is completely silent about the resulting wood product's resistance to termites.

Thus, there is still a need for a method for improving the resistance to rot and termites of a wooden material but without the usage of environmentally harmful or toxic components.

### SUMMARY OF INVENTION

An object of the present disclosure is to provide a method for improving the resistance to rot and termites of a wooden material by utilizing a water-based formulation comprising a zirconium salt.

It is another object of the present disclosure to provide a method for improving the resistance to rot and termites of a wooden material by utilizing a non-environmentally harmful component or a non-toxic component.

It is still another object of the present disclosure to provide a wooden material treated by any method according to the present disclosure, wherein the wooden material exhibits improved resistance to rot and/or termites.

In a first aspect, the present disclosure is directed to a method for treating a wooden material to improve the resistance to rot and termites of the wooden material, wherein the wooden material is treated with a water-based formulation, said method comprising the steps of:
i) providing a wooden material;
ii) providing a water-based formulation comprising a zirconium salt;
iii) applying said water-based formulation on said wooden material; and
iv) drying said wooden material with said water-based formulation at a temperature from 0 degrees C to 100 degrees C.
   The zirconium salt comprised in the water-based formulation acts as a termite repellent and as a rot protecting agent.

By “termite repellent” is meant that the referred compound provides the treated wooden material with improved resistance to termites. Termites' attraction to a wooden material treated with a water-based formulation according to the present disclosure is reduced compared to a non-treated wooden material. The zirconium salt directly contributes to the termite repellency and makes a treated wood unappealing to termites. By termite repellent is also meant termite resistant.

Similarly, the zirconium salt directly contributes to the rot protection of the wooden material.

By such an exemplary method, an environmentally friendly method for improving the resistance to rot and termites of a wooden material is achieved. As the zirconium salt acts as a termite repellent and as a rot protecting agent, the usage of an environmentally harmful component or a toxic component used as biocide and/or insecticide is eliminated. A commonly used biocide exhibiting toxic and environmentally harmful properties is copper.

The water-based formulation may further comprise an additive to improve the handling of the water-based formulation or the impregnation efficiency of the formulation. The additive may be a defoamer.

It has surprisingly been found that applying a water-based formulation comprising a zirconium salt to a wooden material, and drying the material at temperatures from 0 to 100 degrees C, will result in a wooden material with improved termite repellency while also exhibiting rot protection.

Drying at low temperatures is also desirable from an environmental perspective as this decreases the energy consumption during manufacturing.

More precisely, it has been discovered that if a wooden material treated with a water-based formulation comprising a zirconium salt is dried at elevated temperatures, i.e. above 100 degrees C, the termite resistance, will be impaired compared to if a lower drying temperature, i.e. lower than 100 degrees C, is used.

The treatment of a wooden material with a water-based formulation comprising a zirconium salt combined with a drying step according to the present disclosure results in a rot resistant wooden material exhibiting improved termite resistance compared to a wooden material treated with the same water-based formulation but dried at a higher temperature. By higher temperature, is mean a temperature higher than a temperature used in the present disclosure.

Without being bound to theory, it is believed that the temperature used in the present disclosure avoids the formation of degradation products which may be formed if higher temperatures are used. These degradation products may be appealing to termites. Thus, the method according to the present disclosure improves termite resistance of the treated wooden material while at the same time providing rot resistance.

The zirconium salt may be selected from, but not limited to, Zirconium Acetate, Ammonium Zirconium Carbonate, Zirconium Bromide, Zirconium Chloride, Zirconium Hydroxynitrate, Zirconium Nitrate, Zirconium Oxide Diperchlorate Octahydrate, Zirconium Oxychloride, Zirconium Oxynitrate, Zirconium Sulfate, Zirconium Sulfate Tetrahydrate, Zirconyl Chloride, Zirconium Acetate Hydroxide, Zirconium orthosulphate and Zirconium sulphamate.

The wooden materials used with the present disclosure can be selected from spruce, pine, birch, oak, redwood, cedar or composite materials such as plywood, fiber boards, particle boards, or pulp based materials such as paperboard, corrugated board, gypsum grade paperboard, specialty paper or molded pulp products.

The drying step iv) according to the present disclosure can be performed by using any drying and heating techniques under different atmospheric conditions such as Westwood process, ThermoWood process, Plato Process (Ruyter 1989; Boonstra, Tjeerdsma and Groeneveld 1998), Retification (Vernois 2000), Les Bois Procedure, Thermovacuum process (Vacwood), microwave, IR, pulse, induction, air drying, Kiln-drying, and similar. Furthermore, the drying step iv) can also be performed without any additional drying help, meaning that the treated wooden material can be dried at ambient temperature both indoors or outdoors depending on conditions. Non-limiting examples of atmospheric conditions that can be used are inert atmospheres such as nitrogen atmosphere, steam and ambient atmosphere or reduced ambient atmosphere. The drying step can be done under different program cycles, heating rates and heating times.

In one exemplary method, the water-based formulation does not comprise any additional biocide, fungicide and/or termite repellent present in an amount sufficient to act as a biocide, fungicide and/or termite repellent. In one exemplary method, the water-based formulation does not comprise any additional biocide.

Treating a wooden material with a water-based formulation according to the present disclosure results in an improvement in the resistance to rot and termites of the wooden material without the need of any additional biocide, fungicide and/or termite repellent to be present in the water-based formulation.

In one exemplary method, applying the water-based formulation on the wooden material results in the water-based formulation being impregnated into the structure of the wooden material.

The water-based formulation comprising a zirconium salt does not only impregnate to top surfaces of a wooden material to be treated, but is able to penetrate within the structure of the wooden material.

By such an exemplary method, the water-based formulation is spread within the structure of the wooden material. An improvement in the resistance to rot and termites is therefore achieved within the whole material, and not only to the top surface.

In one exemplary method, the drying step iv) is performed at a temperature from 0 to 80 degrees C, preferably from 10 to 70 degrees C. In one preferred exemplary method, the drying step iv) is performed at an ambient temperature from 20 to 50 degrees C.

It has been discovered that by treating a wooden material with a water-based formulation comprising a zirconium salt and drying at temperatures according to the present disclosure, the resistance to rot and termites of the treated wooden material is improved. It has surprisingly been found that if too high a temperature is used, the resistance to termites is reduced.

As such, a rot resistant wooden material exhibiting improved resistance to termites compared to an untreated wooden material is manufactured. Furthermore, the method is environmentally friendly as the energy consumption is decreased compared to a method utilizing higher drying temperatures.

In one exemplary method, the zirconium salt constitutes the major source of termite repellent and/or rot protecting agent in said water-based formulation.

By such an exemplary method, it is possible to provide an environmentally friendly method as zirconium poses low risk for humans and the environment.

By major source of termite repellent and/or rot protecting agent is meant that if an additional compound that is able to act as a rot protecting agent and/or as a termite repellent is present in the water-based formulation, the zirconium salt is present in a greater amount compared to such an additional compound. In one embodiment, if another source of termite repellent and/or rot protecting agent is present, the zirconium salt amount is at least 70 weight-% or at least 80 weight-% greater compared to the amount of the additional compound acting as a rot protecting agent and/or a termite repellent.

In one exemplary method, the zirconium salt comprises zirconium acetate. In one exemplary method, the zirconium salt is zirconium acetate.

In one exemplary method, the water based formulation additionally comprises a surfactant. A surfactant may be ionic or non-ionic. The surfactant may be chosen from the class of surfactants which are defined as nonionic emulsifiers having HLB (Hydrophilic-Lipophilic balance) values from 1 to 41 and that have wetting properties on wood.

In one exemplary method, the water-based formulation comprises 70 to 99.99 weight-% water, preferably 80-99 weight-% water, preferably 90-97 weight-% water. In one exemplary method, the water-based formulation comprises 90-95 weight-% water.

By having a high amount of water, the formulation is more environmentally friendly as the usage of other solvents, such as organic solvents, is reduced or eliminated.

In one exemplary method, the zirconium salt is provided in an amount sufficient to provide the wooden material with improved resistance to rot and termites.

By such an exemplary method, the treated wooden material's resistance to termites is improved as the termites will not be attracted to the wooden material. As zirconium poses low risk for humans and the environment, such an exemplary method provides an environmentally friendly method to manufacture termite resistant wood.

In one exemplary method, the water-based formulation comprises 0.1-20 weight-% of zirconium salt, preferably 1-15 weight-%, preferably 3-10 weight-% of zirconium salt. In one exemplary method, the water-based formulation comprises 5-10 weight-% of zirconium salt.

It has been discovered that by applying a water-based formulation comprising such an amount of zirconium salt to wooden materials, and drying at temperatures as disclosed in the present disclosure, an improvement in the resistance to rot and termites of the wooden material is achieved.

In one exemplary method, the water-based formulation comprises 3-10 weight-% of zirconium salt and 90-97 weight-% of water.

In one exemplary method, the water-based formulation contains 3-10 weight-% of zirconium salt and 90-97 weight-% of water.

In one exemplary method, the water-based formulation does not contain an environmentally harmful component or a toxic component.

By toxic component is meant a component being poisonous especially when capable of causing death or serious debilitation. By environmentally harmful component is meant a component being a threat to the surrounding natural environment or adversely affect people's health.

As the water-based formulation according to the present disclosure provides the wooden material with improved resistance to rot and termites, without the need of any additional biocide or insecticide, it is possible to provide a formulation that does not pose a risk for humans in contact with the treated wooden material or the environment in which the wooden material is to be used.

In one exemplary method, the water-based formulation has a pH value of 2-13, preferably between 2-9.

In one exemplary method, the application step iii) is performed by vacuum pressure impregnation.

In one exemplary method, the method additionally comprises a pre-treatment step of drying the wooden material to a moisture content of less than 20% before applying the water-based formulation.

By such an exemplary method, a more efficient impregnation of the water-based formulation is achieved.

A drying pre-treatment step can be performed using any drying techniques such as microwave, IR, pulse, induction, air drying, Kiln drying, Dehumidification, Vacuum-drying, Solar kiln, Water seasoning, Boiling or steam seasoning, Chemical or salt seasoning, Electrical seasoning and similar. The method can be performed in the absence or presence of vacuum, inert atmosphere, steam, or ambient atmosphere.

In one exemplary method, the method results in a treated wooden material exhibiting a visual sample termite degradation measured according to EN 117 (2012), adapted for a measurement time of 6 weeks instead of 8 weeks, of less than 3, preferably less than 2.

En 117 (2012) provides a laboratory method for testing the effectiveness of a wood preservative against termites. It allows the determination of the concentration at which the product prevents attack by these insects of impregnated wood of a susceptible species. This laboratory method provides one criterion by which the value of a product can be assessed. EN 117 (2012) has in the present disclosure been adapted for a measurement time of 6 weeks. Treated and untreated wooden materials are subjected to a termite attack and are after the test period given a score between 0-5 based on their visual appearance after the attack, where 0=no attack and 4=heavy attack.

In one exemplary method, the method results in a treated wooden material exhibiting a durability class according to prEn 113-2 (2018) of less than 3, preferably less than 2.

prEn 113-2 (2018) provides a method for determining the durability of a wooden material against wood-destroying fungi. The method is applicable to all timber species. Furthermore this method can be used to test modified wood. Treated and untreated wooden materials are subjected to different strains of fungi and are after the test period given a score between DC1-DC5 based on their durability after the treatment, where DC1=very durable and DC5=not durable.

In a second aspect, the present disclosure is directed to a wooden material treated by a method according to any one of the first aspect.

As previously explained, the wooden materials used with the present disclosure can be selected from spruce, pine, birch, oak, redwood, cedar or composite materials such as plywood, fiber boards, particle boards, or pulp based materials such as paperboard, corrugated board, gypsum grade paperboard, specialty paper or molded pulp products.

A wooden material treated by a method according to any of one of the first aspect will exhibit improved resistance to rot and/or termites. Moreover, as zirconium salt is a non-toxic component, this results in a wooden material exhibiting improved resistance to rot and/or termites without utilizing an environmentally harmful component or a component that is harmful or toxic to humans

In one exemplary wooden material, the wooden material comprises a termite repellent amount of zirconium salt in the wooden material.

In a third aspect, the present disclosure is directed to a product comprising a wooden material according to any one of the second aspect.

A product may be, but is not limited to, outdoors wooden products to be used in patios and gardens, for example deckings, fencing, planter boxes, outdoor furniture and docks.

### DESCRIPTION OF EMBODIMENTS

The detailed description with reference to the disclosed embodiments are to be viewed as examples of combining specific features described above. It is to be understood that additional examples may be achieved by combining other and/or fewer/more features than in the disclosed embodiments. Hence, the figures disclose exemplary embodiments and not exclusive combinations. In this context is should also be noted that, for the sake of simplicity, all figures are schematically disclosed, as long as nothing else is said.

As used herein, “weight-%” refers to weight percent of the ingredient referred to of the total weight of the compound or composition.

### EXAMPLES

In the following examples, different water-based formulations and drying temperatures are analysed. The formulations are applied to a wooden material, following by a drying step, and the resulting rot resistance and termite resistance are evaluated.

### Example 1: General Procedures of the Preparation of Water-Based Formulation According to the Disclosure

### Method 1.

Step a) Mixing a zirconium salt formulation and water in any order of addition, Step b) Adding defoamer, wetting agent and other optional component to the resulting mixture in step a, wherein the resulting mixtures in steps a-b are optionally mixed and/or optionally homogenized.

### Method 2.

Step a) Mixing defoamer, wetting agent and other optional component to the water Step b) Adding zirconium salt to the resulting mixture in step a, wherein the resulting mixtures in steps a-b are optionally mixed and/or optionally homogenized.

The apparatus for preparing the water-based formulation is any kind of laboratory or industrial equipment using low and/or high shear forces for producing the homogenous composition of the invention. This might be a magnet stirrer, overhead stirrer with propeller or disperser or like, homogenizer with or without high pressure, in-line or external homogenizers, extruders, shaking equipment, mortar and pestle, blender type of instrument, any kind of mixer (static mixer, micro mixer, vortex mixer, industrial mixer, ribbon blender, V blender, continuous processor, cone screw blender, screw blender, double cone blender, double planetary, high viscosity mixer, counter-rotation, double and triple shaft, vacuum mixer, high shear rotor stator, dispersion mixer, paddle, jet mixer, mobile mixer, drum mixer, intermix mixer, planetary mixer, Banbury mixer or like), French press, disintegrator, mill (grinding by bead mill, colloid mill, hammer mill, ball mill, rod mill, autogenous mill, semiautogenous grinding, pebble mill, high pressure grinding rolls, buhrstone mill, vertical shaft impactor mill, tower mill or like), ultrasonic treatment, rotor-stator mechanical equipment, any kind of propeller or mixer, high temperature and/or high pressure bitumen emulsifiers or combinations of the above.

### Example 2: Rot Protection

The test was carried out according to prEN 113-2 (2018) Test method against wood destroying basidiomycetes-Part 2. 4 different treatments of pine wood were evaluated according to Table 1.

The applied water-based formulation was prepared according to Method 1. The water-based formulations according to treatment nr 1-4 contained water and zirconium acetate. Treatments 1-3 have different concentration of zirconium acetate as shown in Table 1. The treatments used are shown in Table 1. For this example, a reference material being untreated pine sap wood was used.

TABLE 1

| Treatment nr | Applied water-based formulation | Drying temperature |
|---|---|---|
| 1 | 3% Zirconium acetate | 60 degrees C |
| 2 | 5% Zirconium acetate | 60 degrees C |
| 3 | 10% Zirconium acetate | 60 degrees C |
| 4 | — | max 185 degrees C |

For treatment 1-4, impregnation is carried out during 3 hours at 11 bar at room temperature (approximately 21 degrees C). The wet uptake of water-based formulation was between 730 to 760 kg/m³.

For drying temperature of 60 degrees C, the wooden material was dried for approximately 4-6 days. For drying temperature of 185 degrees C, the temperature was gradually increased over a period of 4-6 days, reaching a maximum temperature of 185 degrees C.

The analysed wooden materials have test block dimensions of 50 mm×25 mm×15 mm. The test was conducted according to prEN 113-2(2018); section 7.2.

The test blocks are first conditioned at 20±2 degrees C at 65±5% humidity until a stable weight is achieved. Following, an ageing test according to EN 84 was carried out.

The fungi analysed was Trametes versicolor, Rhodonia placenta and Coniophora puteana. For each treatment, test blocks are incubated for 112 days with one of the above mentioned fungi. After 112 days, the median mass losses and assessment of inherent or enhanced durability according to prEN 113-2 (2018) annex F1 was tested. The results are presented in Table 2.

TABLE 2

| | Median mass loss in % | | | Durability class |
|---|---|---|---|---|
| Treatment | Coniophora | Rhodonia | Trametes | according to prEn |
| nr | puteana | placenta | versicolor | 113-2 annex F1 |
| 1 | 5.8 | 12.4 | 18.2 | DC 4 |
| 2 | 1.4 | 6.3 | 13.8 | DC 3 |
| 3 | 0.7 | 1.9 | 1.4 | DC 1 |
| 4 | 29.0 | 42.1 | 16.4 | DC 5 |

The durability rating scale according to prEN 113-2 annex F1 is defined as following in Table 3

TABLE 3

| Durability class | Description | Percentage mass loss |
|---|---|---|
| DC 1 | Very durable | ≤5 |
| DC 2 | Durable | >5 to ≤10 |
| DC 3 | Moderately durable | >10 to ≤15 |
| DC 4 | Slightly durable | >15 to ≤30 |
| DC 5 | Not durable | >30 |

As can be seen in Tables 2 and 3, the treated wooden material exhibits good rot resistant properties. Furthermore, by increasing the concentration of zirconium salt in the water-based formulation, it is possible to achieve greater rot resistance.

### Example 3: Termite Resistance

In this test, the termite feeding behaviours on variants of modified pine wood are tested. Furthermore, untreated pine sap wood and untreated oak sap wood was also tested as reference and virulence control. The test was carried out according to EN 117 (2012), adapted for a measurement time of 6 weeks.

7 different treatments of treated and untreated pine wood were evaluated according to Table 4.

The applied water-based formulation was prepared according to Method 1. The water-based formulations according to treatment nr 1-4 contained water and zirconium acetate. Treatments 1-4 have different concentration of zirconium acetate as shown in Table 4. The treatments used are shown in Table 4. For this example, a reference material being untreated pine sap wood was used.

TABLE 4

| Treatment nr | Applied water-based formulation | Drying temperature |
|---|---|---|
| 1 | 3% Zirconium acetate | 60 degrees C |
| 2 | 5% Zirconium acetate | 60 degrees C |
| 3 | 10% Zirconium acetate | 60 degrees C |
| 4 | 3% Zirconium acetate | max 185 degrees C |
| 5 | — | max 185 degrees C |

| | |
|---|---|
| 9 | Untreated pine sap wood as reference |
| | and virulence control |
| 10 | Untreated oak sap wood as reference |
| | and virulence control |

For treatment 1-4, impregnation was carried out during 3 hours at 11 bar at room temperature (approximately 21 degrees C). The wet uptake of water-based formulation was between 730 to 760 kg/m³.

For drying temperature of 60 degrees C, the wooden material was dried for approximately 4-6 days. For drying temperature of 185 degrees C, the temperature was gradually increased over a period of 4-6 days, reaching a maximum temperature of 185 degrees C.

The analysed wooden material had test block dimensions of 25×15×5 mm. 6 replicates per treatment was performed. Glass vessels filled with moistened vermiculite was used as test vessels.

In each test vessel, a complete set of test samples treated according to Treatment 1-10 as presented in Table 4 are fixed. A shortened version of ageing test according to EN 84 was performed, with the duration being changed to 2 days instead of 14 days, due to the small size of the test blocks used. After this, the test samples were conditioned for 3 days at 20 degrees C and 65% humidity.

Following the conditioning, 120 termite works and 10 soldiers of the termite species Mastotermed darwiniensis are placed in each test vessel, and the termite feeding behaviours was studies according to EN 117 (2012) adapted to a measurement time of 6 weeks.

After one week of termite attack, Treatment 1-3 show little termite degradation.

After three weeks of termite attack, Treatment 1-3 have not been attacked any further and termite feeding is concentrated on Treatment 4-5 as well as on the untreated pine sap wood and oak pine sap wood.

After six weeks of termite attack, only Treatment 1-3 remained more or less intact. Treatment 4-5 were heavily attacked, in most cases more severely than untreated pine sap wood (Treatment 9).

None of the attacked test samples seems to be acutely toxic, as the colonies survived at high rates (83 to 95%) after six weeks.

After 6 weeks, each test sample was given a visual evaluation based on EN 117 (2012). The results are presented in Table 5. Table 5 represent the mean value of the six replicates performed for each Treatment.

TABLE 5

| | Visual evaluation of test blocks |
|---|---|
| | according to EN 117 (2012) adapted |
| Treatment | for a measurement time of 6 weeks |
| 1 | 1.7 |
| 2 | 1.5 |
| 3 | 1.3 |
| 4 | 4.0 |
| 5 | 4.0 |
| 9 | 2.3 |
| 10 | 3.7 |

The visual evaluation based on EN 117 (2012) adapted to a measurement time of 6 weeks is defined as follows in Table 6

TABLE 6

| Visual evaluation | Description | |
|---|---|---|
| 0 | No attack | |
| 1 | Only traces of | Only on the surface; <1 |
| | gnawing | mm depth |
| 2 | Slight attack | ≥1 mm-<3 mm depth |
| 3 | Medium attack | ≥3 mm but test block not |
| | | pierced yet |
| 4 | Heavy attack | Breakthrough, test block |
| | | pierced |

As can be seen in Tables 5 and 6, when comparing treatment 1 with treatment 4 it is evident that increasing the drying temperature to above 100 degrees C, more precisely 185 degrees C, impairs the termite resistant properties of the treated wooden material. Furthermore, by increasing the concentration of zirconium salt in the water-based formulation, it is possible to further slightly improve the overall termite resistance.

Test materials according to Treatment 1-3 all exhibit better termite resistance compared to the untreated samples (Treatments 9-10).

### Example 4: Drying at Room Temperature

The test was carried out to assess the durability of wooden material impregnated with a water-based formulation according to the present disclosure and compare the durability to a copper-impregnated wooden material. The test was carried out according to EN-113-2 (2020) and EN 350 (2016) in combination with a leaching procedure according to EN 84 (2020).

The applied water-based formulation comprising zirconium was prepared according to Method 1. The water-based formulations according to treatment nr 1-6 contained water and zirconium acetate. Treatments 1-6 have different concentration of zirconium acetate as shown in Table 7. The treatments used are shown in Table 7. For this example, a reference material being a Copper-impregnated timber according to Nordiska Träskyddsrådet (NTR) regulation treatment class NTR AB was used.

TABLE 7

| | Applied water-based | |
|---|---|---|
| Treatment nr | formulation | Drying temperature |
| 1 | 5% Zirconium acetate | 23 degrees C |
| 2 | 6% Zirconium acetate | 23 degrees C |
| 3 | 7% Zirconium acetate | 23 degrees C |
| 4 | 8% Zirconium acetate | 23 degrees C |
| 5 | 9% Zirconium acetate | 23 degrees C |
| 6 | 10% Zirconium acetate | 23 degrees C |
| Copper impregnated | — | 23 degrees C |
| timber (NTR/AB) | | |

For each treatment, test blocks of 50×20×15 mm are used. The number of test block per test product is 100 for treatments 1-6 and 30 for the reference timber.

For treatment 1-6, impregnation is carried out during 2 hours at 11 bar at room temperature (ca 21 degrees C). The wet uptake of water-based formulation was approximately 600 kg/m³.

Afterwards, the impregnated test blocks are dried in a cabinet at 23 degrees C for 4 days. Thereafter the samples are placed in the climate room (23 degrees, 50% RH) for further drying. Following, an ageing test according to EN 84 was carried out.

The fungi analysed was Trametes versicolor and Coniophora puteana. For each treatment, test blocks are incubated for 112 days with one of the above mentioned fungi. After 112 days, the median mass losses according to prEN 113-2 (2020). The results are presented in Table 8.

TABLE 8

Median mass loss in %

| Treatment nr | Coniophora puteana | Trametes versicolor |
|---|---|---|
| 1 | 6.7 | 1.8 |
| 2 | 5.3 | 2.1 |
| 3 | 2.7 | 1.5 |
| 4 | 5.4 | 1.0 |
| 5 | 2.3 | 1.1 |
| 6 | 4.5 | 1.1 |
| Copper impregnated | 8.2 | 0.8 |
| timber (NTR/AB) | | |

As can be seen in Table 8, a method according to the present disclosure treating a wooden material with a water-based formulation according to the present disclosure and drying at room temperature (23 degrees C) exhibits good rot resistant properties. When comparing with a Copper impregnated timber according to class NTR/AB, the method according to the present disclosure results in equal or improved properties. Furthermore, by increasing the concentration of zirconium salt in the water-based formulation, it is possible to achieve greater rot resistance.

1. A method for treating a wooden material to improve the resistance to rot and termites of the wooden material, wherein the wooden material is treated with a water-based formulation, said method comprising the steps of:
i) providing a wooden material;
ii) providing a water-based formulation comprising a zirconium salt;
iii) applying said water-based formulation on said wooden material;
iv) drying said wooden material with said water-based formulation at a temperature from 0 degrees C to 100 degrees C;
wherein the zirconium salt comprised in the water-based formulation acts as a termite repellent and as a rot protecting agent.

2. The method according to claim 1, wherein the water-based formulation does not comprise any additional biocide, fungicide and/or termite repellent present in an amount sufficient to act as a biocide, fungicide and/or termite repellent.

3. The method according to claim 1, wherein the drying step iv) is performed at a temperature from 0 to 80 degrees C.

4. The method according to claim 1, wherein the zirconium salt constitutes the major source of termite repellent and/or rot protecting agent in the water-based formulation.

5. The method according to claim 1, wherein the zirconium salt comprises zirconium acetate.

6. The method according to claim 1, wherein the water based formulation additionally comprises a surfactant.

7. The method according to claim 1, wherein the water-based formulation comprises 70 to 99.99 weight-% water.

8. The method according to claim 1, wherein the zirconium salt is provided in an amount sufficient to provide the wooden material with improved resistance to rot and termites.

9. The method according to claim 1, wherein the water-based formulation comprises 0.1-20 weight-% of zirconium salt.

10. The method according to claim 1, wherein the water-based formulation comprises 3-10 weight-% of zirconium salt and 90-97 weight-% of water.

11. The method according to claim 1, wherein the water-based formulation contains 3-10 weight-% of zirconium salt and 90-97 weight-% of water.

12. The method according to claim 1, wherein the water-based formulation does not contain an environmentally harmful component or a toxic component.

13. The method according to claim 1, wherein the water-based formulation has a pH value of 2-13.

14. The method according to claim 1, wherein the application step iii) is performed by vacuum pressure impregnation.

15. The method according to claim 1, said method additionally comprising a pre-treatment step of drying the wooden material to a moisture content of less than 20% before applying the water-based formulation.

16. The method according to claim 1, wherein the method results in a treated wooden material exhibiting a visual sample termite degradation, measured according to EN 117 (2012), adapted for a measurement time of 6 weeks.

17. (canceled)

18. A wooden material treated by the method according to claim 1.

19. (canceled)

20. (canceled)

21. The method according to claim 6, wherein the surfactant is selected from an ionic or a non-ionic surfactant.

22. The method according to claim 1, wherein the water-based formulation comprises 5-10 weight-% of zirconium salt and 90-95 weight-% of water.

23. The method according to claim 1, wherein the water-based formulation contains 5-10 weight-% of zirconium salt and 90-95 weight-% of water.
